(19) United States
(12) Patent Application Publication
(10) Pub. No.: US 2009/0025682 A1
(43) Pub. Date: Jan. 29, 2009

(54) CONTROLLER FOR SPRAY-GUIDE TYPE DIRECT INJECTION INTERNAL COMBUSTION ENGINE

(75) Inventor: Akihiro OKAMOTO, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/178,110

(22) Filed: Jul. 23, 2008

(30) Foreign Application Priority Data
Jul. 24, 2007 (JP) 2007-191509

(51) Int. Cl. F02P 5/15; F02D 41/30; F02P 15/00

(52) U.S. Cl. 123/406.47; 701/103; 123/445

(57) ABSTRACT

A combustion state of each cylinder is determined during a compression stroke injection mode (stratified combustion mode) or an intake-compression stroke divided injection mode (weak stratified combustion mode). When a combustion deterioration is detected, a combustion improvement control is performed in order to improve the combustion state. During the combustion improvement control, the fuel injection which is supposed to be performed in one compression stroke is divided into a plurality of injections. Alternatively, a total spark period is prolonged in a retard direction, a fuel injection timing is corrected to be advanced, or a fuel pressure is reduced.

### CROSS-REFERENCE TO RELATED APPLICATION

This application is based on Japanese Patent Application No. 2007-191509 filed on Jul. 24, 2007, the disclosure of which is incorporated herein by reference.

### FIELD OF THE INVENTION

The present invention relates to a controller for a spray-guide type direct injection engine in which fuel is injected into a combustion chamber from a substantial upper center of the combustion chamber.

### BACKGROUND OF THE INVENTION

Generally, a direct injection engine has a fuel injector which obliquely downwardly injects fuel into a combustion chamber from a side wall of the combustion chamber (vicinity of the intake port). The injected fuel collides with a recess formed on a top surface of a piston, and is guided to an upper part of the piston by an inner peripheral wall of the recess. Such an injection method is called a wall-guide type injection.

If the injected fuel adheres to the piston top surface or the cylinder inner wall surface, the adhering fuel will remain as uncombusted hydrocarbon (HC). When the fuel (wet) adhering to the piston top surface or the cylinder inner wall surface increases, a quantity of discharged HC increases to deteriorate exhaust emission.

In order to solve the above problems, a spray-guide type (center injection type) direct injection engine has been developed. The spray-guide type direct injection engine, as shown in JP-2005-105877A, has a fuel injector which downwardly injects the fuel into a combustion chamber from a substantial upper center of a combustion chamber. An injection force (penetrating force) of the fuel is established in such a manner that the injected fuel does not collide with a piston upper surface and a cylinder inner surface, so that amount of fuel adhering on the piston upper surface and the cylinder inner surface can be decreased.

In the spray-guide type direct injection engine, as shown in FIGS. 2 and 3, the fuel injector 19 and the spark plug 20 are arranged close to each other. A part of the fuel-spray injected by the fuel injector 19 is directly sprayed on a tip portion (spark generating portion) of the spark plug 20. It cannot be avoided that a ground electrode 38 protruding into a fuel-spray area SA becomes an obstacle which disturbs the fuel-spray.

Since the spark plug 20 is fixed by fastening a thread part 39 formed in an outer peripheral of a metal housing into a screw-thread plug hole 40 of the cylinder head 31, the direction of the ground electrode 38 changes due to manufacture dispersion of thread-part 39 and the screw-thread plug hole 40, and dispersion of the fastening force of the spark plug 20. As mentioned above, in the spray-guide type direct injection engine, the ground electrode 38 protruding to the fuel-spray area SA serves as the obstacle which interrupts a part of fuel-spray. Therefore, if the direction of the ground electrode 38 changes, a shape of the fuel-spray is also changed.

Generally, in the direct injection engine, according to the engine operation conditions (engine speed, required torque, etc.), an injection mode (combustion mode) is switched between a homogeneous combustion mode (intake stroke injection mode), a stratified combustion mode (compression stroke injection mode), and a weak stratified combustion mode (intake-compression stroke divided injection mode). In the homogeneous combustion mode where the fuel is injected in the intake stroke, since the combustion chamber is filled with the homogeneous air-fuel mixture, the combustion state does not change due to the direction of the ground electrode 38. In the stratified combustion mode and the weak stratified combustion mode in which the fuel is injected in the compression stroke, the thick air-fuel mixture is partially formed at a vicinity of the spark-plug 20. Hence, if a state of the fuel-spray changes due to the direction of the ground electrode 38, the state of the air-fuel mixture at a vicinity of the spark-plug 20 is changed and the combustion state is changed. For this reason, as shown in FIG. 4, depending on the direction of the ground electrode 38, the combustion state may be deteriorated. According to an experiment conducted by the inventor, when the fuel injector injects fuel toward the spark plug 20, a combustion state deteriorates in a case that the ground electrode 38 faces the fuel injector 19 more than in a case that the ground electrode 38 faces an opposite side of the fuel injector 19.

### SUMMARY OF THE INVENTION

The present invention is made in view of the above matters, and it is an object of the present invention to provide a controller for a spray-guide type direct injection engine, which is able to prevent deterioration of a combustion state due to a direction of the ground electrode of the spark plug, and to realize favorable stratified combustion and weak stratified combustion which are not influenced by the direction of the ground electrode of the spark plug.

According to the present invention, a controller includes a fuel injector which directly injects fuel into a combustion chamber from a substantial upper center of the combustion chamber, and a fuel injection control means for performing a fuel injection in a compression stroke injection mode in which the fuel is injected in a compression stroke to perform a stratified combustion or in an intake-compression stroke divided injection mode to perform a weak stratified combustion. The controller further includes a combustion state determination means for determining a combustion state in each cylinder while the fuel injection is performed in the compression stroke injection mode or the intake-compression stroke divided injection mode. When the combustion determination means detects a combustion deterioration in any cylinders, the fuel injection control means performs a combustion improvement control in which the fuel injection which is supposed to be performed in one compression stroke is divided into a plurality of fuel injections in the compression stroke with respect to the cylinder or all cylinders.

Thereby, the fuel quantity per one fuel injection is decreased and the penetrating force of the fuel-spray is reduced. The adverse effect of the ground electrode to the fuel-spray becomes small, and the forming condition of the air-fuel mixture around the spark plug is improved. The deterioration of the combustion condition due to the direction of the ground electrode of the spark plug can be avoided. The stratified combustion and the weak stratified combustion can be well performed without respect to the direction of the ground electrode of the spark plug.

According to another aspect of the invention, in a case that the fuel injection is divided into two injections in one compression stroke when the combustion deterioration is detected, the fuel-injection-terminate timing of the second injection may be set to the fuel-injection-terminate timing of a case that the fuel injection is not divided, and the fuel-injection-terminate timing of the first injection can be close to the fuel-injection-start timing of the second injection.

Alternatively, in a case that the fuel injection is divided into two injections in one compression stroke, the fuel injection quantity in the first injection can be set smaller than that in the second injection.

According to another aspect of the invention, the controller further includes an ignition control means. When a combustion deterioration is detected in any cylinders by the combustion state determination means, the ignition control means performs a combustion improvement control in which a total spark period in the cylinder or all cylinders is prolonged in a retard direction.

A multi-point ignition can be performed in order to prolong the total spark period in the retard direction.

In performing the multi-ignition when the combustion deterioration is detected, the spark period per one spark may be made shorter than usual and the number of spark may be set greater than usual.

Alternatively, in performing the multi-ignition when the combustion deterioration is detected, the spark period per one spark may be made longer than usual and the number of spark is set less than usual.

Alternatively, the combustion improvement control can be performed by correcting the fuel injection timing to be advanced in a compression stroke.

Alternatively, the combustion improvement control can be performed by correcting the ignition timing to be retarded in a compression stroke.

The controller may include an intake air quantity control means which increases the intake air flow rate to restrict a torque decrease when the torque is decreased due to an execution of the combustion improvement control.

The controller may include the fuel pressure control means which performs a combustion improvement control in which the fuel pressure is reduced, when the combustion deterioration of any cylinders is detected.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of an engine control system of a spray-guide type direct injection engine according to an embodiment of the present invention;

FIG. 2 is a vertical sectional view showing a fuel injector and its vicinity;

FIG. 3 is a chart showing an arrangement of a fuel injector, a spark plug, intake valves and exhaust valves;

FIG. 4 is a graph showing a relationship between a direction of a ground electrode and a combustion deterioration degree;

FIG. 5 is a chart showing a result of experiment in which a relationship between a crank angle from a fuel-injection-terminate timing to a fuel ignition timing, a combustion deterioration degree, and a direction of a ground electrode; and

FIG. 6 is a flowchart showing a combustion improvement control routine.

### DETAILED DESCRIPTION OF EMBODIMENTS

An embodiment of the present invention will be described hereinafter.

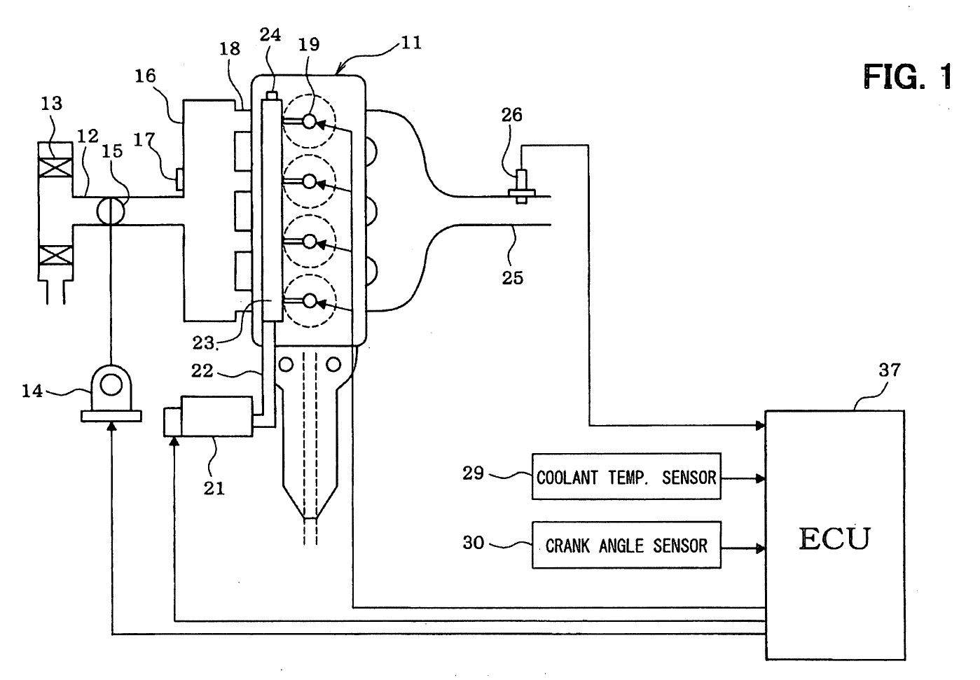

Referring to FIG. 1, an engine control system is explained. An air cleaner 13 is arranged upstream of an intake pipe 12 of a spray-guide type direct injection engine 11. A throttle valve 15 is arranged downstream of the air cleaner 13. A motor 14 adjusts an opening degree of the throttle valve 15. A surge tank 16 including an intake air pressure sensor 17 is provided downstream of the throttle valve 15. The intake air pressure sensor 17 detects intake air pressure. An intake manifold 18 which introduces air into each cylinder of the engine 11 is connected to the surge tank 16.

A fuel injector 19 is provided on a cylinder head 31 of the engine 11 to inject fuel directly into each cylinder. The fuel discharged from a high-pressure fuel pump 21 is sent to a delivery pipe 23 through a fuel pipe 22, and is distributed to the fuel injector 19 of each cylinder from this delivery pipe 23. The fuel pressure sensor 24 which detects pressure (fuel pressure) of the fuel supplied to the fuel injector 19 is attached to the delivery pipe 23.

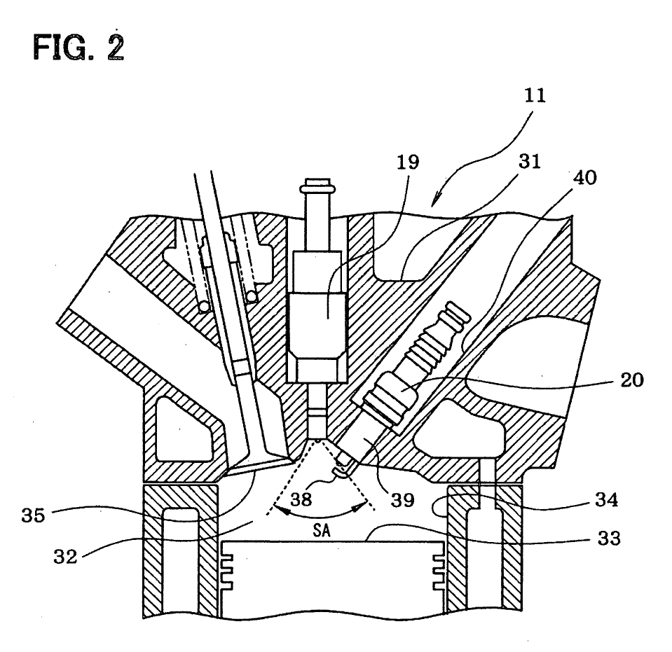

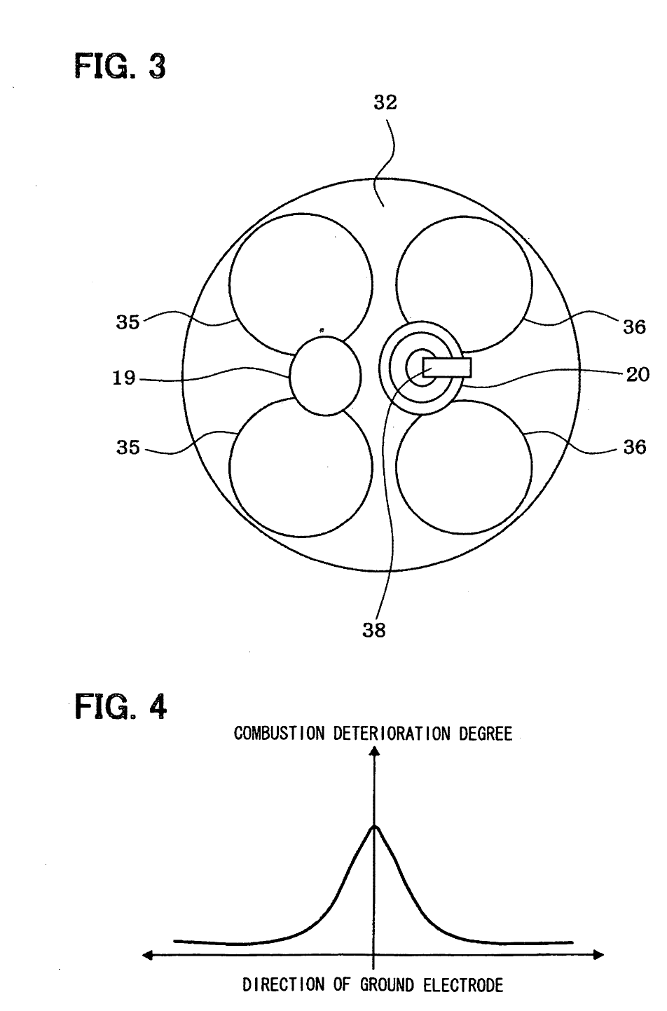

As shown in FIGS. 2 and 3, intake valves 35, exhaust valves 36, and a spark plug 22 are mounted on a cylinder head 31 of the engine 11 corresponding to each cylinder to ignite air-fuel mixture in each cylinder.

As shown in FIG. 2, the engine 11 is a spray-guide type direct injection engine. The fuel injector 19 is provided in a substantial upper center of a combustion chamber 32 at a vicinity of the spark plug 20. The fuel is injected from the injector 19 downwardly. An injection force (penetrating force) of the fuel is established in such a manner that the injected fuel does not collide with a piston upper surface 33 and a cylinder inner surface 34, so that amount of fuel adhering on the piston upper surface 33 and the cylinder inner surface 34 can be decreased.

As shown in FIG. 1, an exhaust gas sensors 26 (an air fuel ratio sensor, an oxygen sensor, etc.) which detect the air-fuel ratio, or rich/lean of the exhaust gas are provided in an exhaust pipe 25 of the engine 11.

A coolant temperature sensor 29 detecting a coolant temperature, and a crank angle sensor 30 outputting a pulse signal every predetermined crank angle of a crankshaft of the engine 11 are disposed on a cylinder block of the engine 11. A crank angle and an engine speed are detected based on the output signal of the crank angle sensor 30.

The outputs of the sensors are inputted to an electronic control unit (ECU) 37. The ECU 37 includes a microcomputer which executes an engine control program stored in a Read Only Memory (ROM) to control a fuel injection quantity and an ignition timing according to an engine operation condition.

According to the engine operation conditions (engine speed, required torque, etc.), the ECU 37 switches an injection mode (combustion mode) between a compression stroke injection mode (stratified combustion mode), an intake-compression stroke divided injection mode (weak stratified combustion mode), and an intake stroke injection mode (homogeneous combustion mode). In the compression stroke injection mode (stratified combustion mode), a little amount of fuel is directly injected into the cylinder during a compression stroke. A stratified air-fuel mixture is formed at a vicinity of the spark plug 20 to perform a stratified combustion (lean combustion) to improve fuel economy. In the intake-compression stroke divided injection mode (weak stratified combustion mode), the fuel is injected in the intake stroke and the compression stroke. In the intake stroke, a thin homogeneous air-fuel mixture is formed, and in the compression stroke, a thick stratified air-fuel mixture is formed near the spark plug 20 to perform the weak stratified combustion. In the intake stroke injection mode (homogeneous combustion mode), a fuel injection quantity is increased and the fuel is directly injected into the cylinder during the intake stroke. A homogenous air-fuel mixture is formed to perform a homogeneous combustion to improve an engine output.

In the spray-guide type direct injection engine 11, as shown in FIGS. 2 and 3, the fuel injector 19 and the spark plug 20 are arranged close to each other. A part of the fuel-spray injected by the fuel injector 19 is directly sprayed on a tip portion (spark generating portion) of the spark plug 20. It cannot be avoided that a ground electrode 38 protruding into a fuel-spray area SA becomes an obstacle which disturbs the fuel-spray.

Since the spark plug 20 is fixed by fastening a thread part 39 formed in an outer peripheral of a metal housing into a screw-thread plug hole 40 of the cylinder head 31, the direction of the ground electrode 38 changes due to manufacture dispersion of thread-part 39 and the screw-thread plug hole 40, and dispersion of the fastening force of the spark plug 20. As mentioned above, in the spray-guide type direct injection engine, the ground electrode 38 protruding to the fuel-spray area SA serves as the obstacle which interrupts a part of fuel-spray. Therefore, if the direction of the ground electrode 38 changes, a shape of the fuel-spray is also changed.

In the suction stroke injection mode (homogeneous combustion mode), since the combustion chamber 32 is filled with the homogeneous air-fuel mixture, the combustion state does not change due to the direction of the ground electrode 38. In the stratified combustion mode and the weak stratified combustion mode in which the fuel is injected in the compression stroke, the thick air-fuel mixture is partially formed at a vicinity of the spark-plug 20. Hence, if the fuel-spray state changes due to the direction of the ground electrode 38, the state of the air-fuel mixture at a vicinity of the spark-plug 20 is changed and the combustion state is changed. For this reason, depending on the direction of the ground electrode 38, the combustion state may be deteriorated.

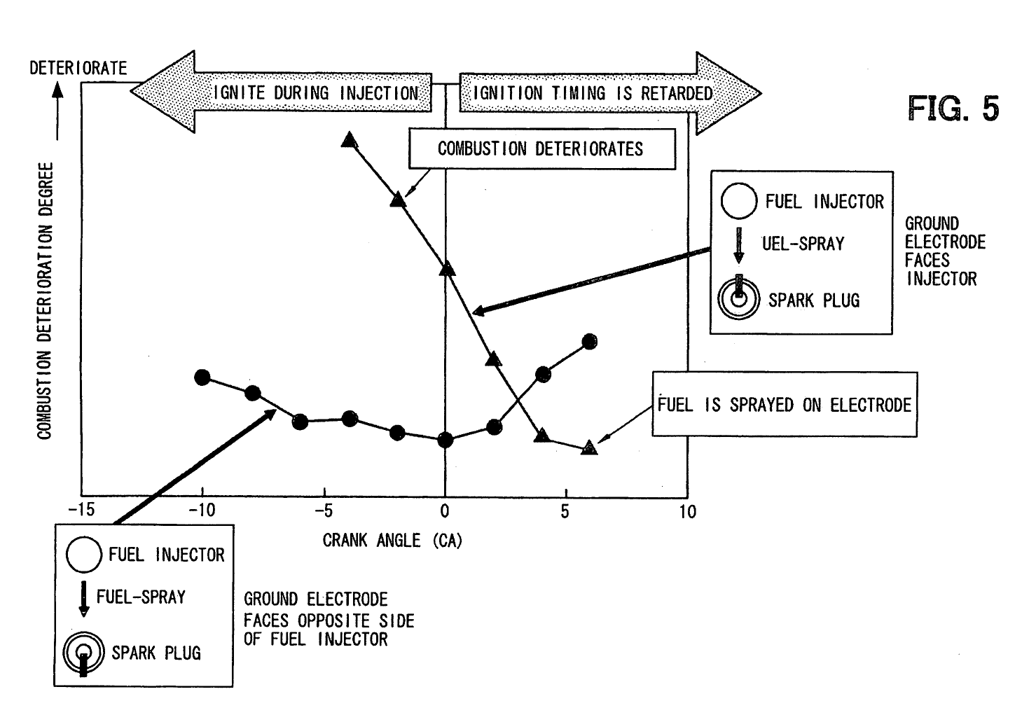

FIG. 5 is an experiment result, which is obtained by the present inventors, showing a relationship between a crank angle from a fuel injection terminating timing to an ignition timing, a combustion deterioration degree, and a direction (position) of the ground electrode 38 in a case of the stratified combustion mode. In this experiment, one fuel injection is performed in one compression stroke and the ignition timing is set at BTDC10 [CA]. A part of the fuel-spray from the fuel injector 19 is injected toward the spark plug 20 in this operating condition. This experiment result shows the combustion deterioration degree in a case that the ground electrode 38 faces the fuel injector 19, and the combustion deterioration degree in a case that the ground electrode 38 faces an opposite side of the fuel injector 19 are evaluated. In a situation that the ignition timing and fuel injection terminating timing coincide with each other and the ground electrode 38 faces the fuel injector 19, the combustion state deteriorates. Even in this situation, if the ignition timing is retarded more than the fuel injection terminating timing, the combustion state is improved. Similarly, if the fuel injection terminating timing is advanced, the combustion state is improved. Besides, if a penetrating force of the fuel-spray is decreased, the interrupting effect of the ground electrode 38 becomes small, so that forming condition of the air fuel mixture at a vicinity of the spark plug 20 is improved.

When the engine 11 is in the compression stroke injection mode (stratified combustion mode) or the intake-compression stroke divided injection mode (weak stratified combustion mode), the ECU 37 determines the combustion condition in each cylinder based on a variation in engine speed, a variation in incylinder pressure (combustion pressure), and a variation in combustion ion current. If a combustion deterioration is detected in any cylinders, the ECU 37 performs a combustion improvement control to improve the combustion condition.

In this embodiment, the combustion improve control is performed by at least one of five methods, which will be described hereinafter.

### [Combustion Improve Control (1)]

In a case of the compression stroke injection mode (stratified combustion mode) or the intake-compression stroke divided injection mode (weak stratified combustion mode), when a combustion deterioration is detected in any cylinders, one fuel injection which will be performed in one compression stroke is divided into multiple fuel injections in the compression stroke with respect to the deteriorated cylinder or all cylinders. Thereby, the fuel quantity per one fuel injection is decreased and the penetrating force of the fuel-spray is reduced. The adverse effect of the ground electrode 38 to the fuel-spray becomes small, and the forming condition of the air-fuel mixture around the spark plug 20 is improved.

According to the experiment conducted by the inventor, as the fuel-injection-terminate timing of a first injection in the divided injections becomes earlier, the emission is more deteriorated. Furthermore, when the fuel injection quantity of the first injection is greater than that of a second injection, the emission is deteriorated.

In a situation that the fuel injection is divided into two injections in one compression stroke and the combustion deterioration is detected, the fuel-injection-terminate timing of the second injection may be set to a fuel-injection-terminate timing of a case where the fuel injection is not divided, and the fuel-injection-terminate timing of the first injection can be close to the fuel-injection-start timing of the second injection as much as possible. Thereby, since the fuel-injection-terminate timing of the first injection is delayed, the deterioration of the emission can be avoided.

Alternatively, in a situation that the fuel injection is divided into two injections in one compression stroke, the fuel injection quantity in the first injection can be set smaller than that in the second injection. Since the fuel injection quantity in the first injection can be reduced, the deterioration of the emission can be avoided.

### [Combustion Improve Control (2)]

In a case of the compression stroke injection mode (stratified combustion mode) or the intake-compression stroke divided injection mode (weak stratified combustion mode) when a combustion deterioration is detected in any cylinders, a total spark period of the spark plug is prolonged in a retard direction with respect to the deteriorated cylinder or all cylinders. Hence, the ignition can be maintained until a retarded time when the combustion state is improved. The deterioration of the combustion condition due to the direction of the ground electrode of the spark plug can be avoided. The stratified combustion and the weak stratified combustion can be well performed without respect to the direction of the ground electrode of the spark plug.

A multi-point ignition can be performed in order to prolong the total spark period in the retard direction.

In a system where a multi-ignition is performed in the compression stroke injection mode or the intake-compression stroke injection mode, a spark period per one spark may be made shorter than usual and the number of spark may be set greater than usual. A dispersion of the total spark period in prolonging the total spark period by performing the multi-ignition can be reduced.

Alternatively, in performing the multi-ignition when the combustion deterioration is detected, the spark period per one spark may be made longer than usual and the number of spark is set less than usual. Thereby, the performance of ignition is improved when the multi-ignition is performed.

### [Combustion Improve Control (3)]

In a case of the compression stroke injection mode (stratified combustion mode) or the intake-compression stroke divided injection mode (weak stratified combustion mode), when a combustion deterioration is detected in any cylinders, a fuel injection timing in the cylinder is corrected to be advanced in the compression stroke. Since the fuel injection timing is advanced relative to the ignition timing, the ignition can be performed after the fuel injection is terminated. The ground electrode 38 hardly interrupts the fuel-spray so that the combustion state is improved. The stratified combustion and the weak stratified combustion can be performed well without respect to the direction of the ground electrode 38.

### [Combustion Improve Control (4)]

In a case of the compression stroke injection mode (stratified combustion mode) or the intake-compression stroke divided injection mode (weak stratified combustion mode), when a combustion deterioration is detected in any cylinders, an ignition timing in the cylinder is corrected to be retarded. Since the ignition timing is retarded relative to the fuel injection timing, the ignition can be performed after the fuel injection is terminated. The ground electrode 38 hardly interrupts the fuel-spray so that the combustion state is improved. The stratified combustion and the weak stratified combustion can be performed well without respect to the direction of the ground electrode 38.

### [Combustion Improve Control (5)]

In a case of the compression stroke injection mode (stratified combustion mode) or the intake-compression stroke divided injection mode (weak stratified combustion mode), when a combustion deterioration is detected in any cylinders, fuel pressure (discharge pressure of the fuel pump 21) supplied to the fuel injector 19 is decreased. Since the penetrating force of the fuel-spray is reduced by decreasing the fuel pressure at the detection of the combustion deterioration, the ground electrode 38 hardly interrupts the fuel-spray in the stratified combustion mode or the weak stratified combustion mode, so that the forming state of the air-fuel mixture at a vicinity of the spark plug 20 is improved. The stratified combustion and the weak stratified combustion can be performed well without respect to the direction of the ground electrode 38.

If two or more kinds of the combustion improvement control explained above are combined and performed, it may be able to enlarge the combustion improvement effect.

For example, the combustion improve control (1) and (2) may be combined. When the combustion deterioration is detected in any cylinders, one fuel injection which will be performed in one compression stroke is divided into multiple fuel injections in the compression stroke and a total spark period of the spark plug is prolonged in a retard direction with respect to the deteriorated cylinder or all cylinders. The total fuel injection period is prolonged and the total spark period is also prolonged. Thus, an ignition performance which is appropriate for the divided injection is ensured, and the combustion state is efficiently improved. The emission and the engine torque hardly receive adverse affect.

In a case of performing the combustion improve control (1)-(4), there is a possibility that the torque is decreased. When the torque is decreased, the opening degree of the throttle valve is increased to increase the intake air quantity. A torque decrease can be avoided during the combustion improve control so that the drivability is improved.

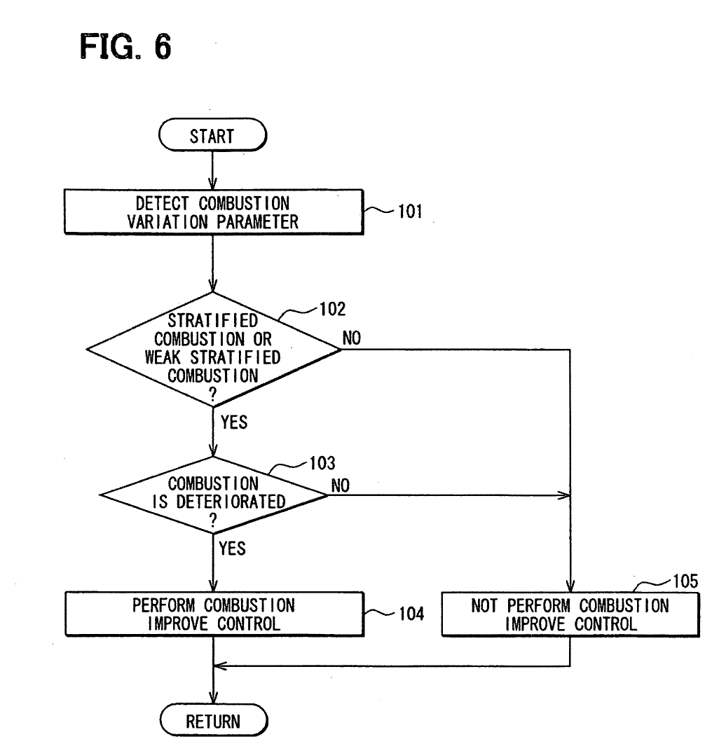

According to a combustion improve control routine shown in FIG. 6, the ECU 37 performs the combustion improve control. The routine shown in FIG. 6 is executed in a specified time period while the engine is running. In step 101, a combustion variation parameter representing a combustion state in each cylinder is detected. For example, variations in inner cylinder pressure per specified period, which is detected by an inner cylinder pressure sensor, can be defined as the combustion variation parameter. Variation in engine speed per specified period, which is detected by the crank angle sensor 30, can be defined as the combustion variation parameter. Variations in combustion ion current value, which is detected through the spark plug 20, can be defined as the combustion variation parameter.

Then, the procedure proceeds to step 102 in which it is determined whether the combustion mode is the stratified combustion mode or the weak stratified combustion mode. When the answer is No, that is, when the combustion mode is the homogeneous combustion mode, the procedure proceeds to step 105 in which the combustion improve control is not performed to end the routine.

When the answer is Yes in step 102, the procedure proceeds to step 103 in which the combustion variation parameter is compared with a threshold to determine whether the combustion state in any cylinder is deteriorated. When no deterioration of combustion state is detected, the procedure proceeds to step 105 in which the combustion improve control is not performed to end the routine.

When the answer is Yes in step 103, the procedure proceeds to step 104 in which at least one of the combustion improve control (1)-(5) is performed to improve the combustion state.

The present invention can be applied to a system which is not provided with one of the compression stroke injection mode (stratified combustion mode) and the intake-compression divided injection mode (weak stratified combustion mode).

What is claimed is:

1. A controller for a spray-guide type direct injection engine, comprising
a fuel injector which directly injects fuel into a combustion chamber from a substantial upper center of the combustion chamber;
a fuel injection control means for performing a fuel injection in a compression stroke injection mode in which the fuel is injected in a compression stroke to perform a stratified combustion or in an intake-compression stroke divided injection mode to perform a weak stratified combustion; and
a combustion state determination means for determining a combustion state in each cylinder while the fuel injection is performed in the compression stroke injection mode or the intake-compression stroke divided injection mode, wherein
when the combustion determination means detects a combustion deterioration in any cylinders, the fuel injection control means performs a combustion improvement control in which the fuel injection which is supposed to be performed in one compression stroke is divided into a plurality of fuel injections in the compression stroke with respect to the cylinder or all cylinders.

2. A controller for a spray-guide type direct injection engine according to claim 1, wherein
in a case that the fuel injection is divided into two injections in one compression stroke when the combustion deterioration is detected, the fuel injection control means set a fuel-injection-terminate timing of a second injection to a fuel-injection-terminate timing of a case that the fuel injection is not divided, and sets a fuel-injection-terminate timing of a first injection close to a fuel-injection-start timing of the second injection.

3. A controller for a spray-guide type direct injection engine according to claim 1, wherein
in a case that the fuel injection is divided into two injections in one compression stroke when the combustion deterioration is detected, a fuel injection quantity of a first injection is less than that of a second injection.

4. A controller for a spray-guide type direct injection engine according to claim 1, further comprising
an ignition control means for controlling an ignition operation, wherein
when a combustion deterioration is detected in any cylinders by the combustion state determination means, the ignition control means prolongs a total spark period in the cylinder or all cylinders in a retard direction.

5. A controller for a spray-guide type direct injection engine, comprising:
a fuel injector which directly injects fuel into a combustion chamber from a substantial upper center of the combustion chamber;
a fuel injection control means for performing a fuel injection in a compression stroke injection mode in which the fuel is injected in a compression stroke to perform a stratified combustion or in an intake-compression stroke divided injection mode to perform a weak stratified combustion;
an ignition control means for controlling an ignition operation; and
a combustion state determination means for determining a combustion state in each cylinder while the fuel injection is performed in the compression stroke injection mode or the intake-compression stroke divided injection mode, wherein
when a combustion deterioration is detected in any cylinders by the combustion state determination means, the ignition control means performs a combustion improvement control in which a total spark period in the cylinder or all cylinders is prolonged in a retard direction.

6. A controller for a spray-guide type direct injection engine according to claim 5, wherein
the ignition control means performs a multi-ignition in order to prolong the total spark period.

7. A controller for a spray-guide type direct injection engine according to claim 6, wherein
the ignition control means performs the multi-ignition when the fuel injection is performed in the compression stroke injection mode or the intake-compression stroke divided injection mode, and when a combustion deterioration is detected, the spark period per one spark is made shorter than a specified time period and the number of spark is set greater than a specified number.

8. A controller for a spray-guide type direct injection engine according to claim 6, wherein
the ignition control means performs the multi-ignition when the fuel injection is performed in the compression stroke injection mode or the intake-compression stroke divided injection mode, and when a combustion deterioration is detected, the spark period per one spark is made longer than a specified time period and the number of spark is set less than a specified number.

9. A controller for a spray-guide type direct injection engine, comprising:
a fuel injector which directly injects fuel into a combustion chamber from a substantial upper center of the combustion chamber;
a fuel injection control means for performing a fuel injection in a compression stroke injection mode in which the fuel is injected in a compression stroke to perform a stratified combustion or in an intake-compression stroke divided injection mode to perform a weak stratified combustion; and
a combustion state determination means for determining a combustion state in each cylinder while the fuel injection is performed in the compression stroke injection mode or the intake-compression stroke divided injection mode, wherein
when the combustion determination means detects a combustion deterioration in any cylinders, the fuel injection control means performs a combustion improvement control in which the fuel injection timing in the compression stroke is corrected to be advanced with respect to the cylinder of which combustion state is deteriorated.

10. A controller for a spray-guide type direct injection engine, comprising:
a fuel injector which directly injects fuel into a combustion chamber from a substantial upper center of the combustion chamber;
a fuel injection control means for performing a fuel injection in a compression stroke injection mode in which the fuel is injected in a compression stroke to perform a stratified combustion or in an intake-compression stroke divided injection mode to perform a weak stratified combustion; an ignition control means for controlling an ignition operation; and
a combustion state determination means for determining a combustion state in each cylinder while the fuel injection is performed in the compression stroke injection mode or the intake-compression stroke divided injection mode, wherein
when the combustion determination means detects a combustion deterioration in any cylinders, the ignition control means performs a combustion improvement control in which the ignition timing is corrected to be retarded with respect to the cylinder of which combustion state is deteriorated.

11. A controller for a spray-guide type direct injection engine according to claim 1, further comprising
an intake air quantity control means for controlling an intake air flow rate, wherein
the intake air quantity control means increases the intake air flow rate to restrict a torque decrease when the torque is decreased due to an execution of the combustion improvement control.

12. A controller for a spray-guide type direct injection engine, comprising:
a fuel injector which directly injects fuel into a combustion chamber from a substantial upper center of the combustion chamber;
a fuel injection control means for performing a fuel injection in a compression stroke injection mode in which the fuel is injected in a compression stroke to perform a stratified combustion or in an intake-compression stroke divided injection mode to perform a weak stratified combustion;
a fuel pressure control means which controls a fuel pressure representing a pressure of the fuel supplied to the fuel injector; and
a combustion state determination means for determining a combustion state in each cylinder while the fuel injection is performed in the compression stroke injection mode or the intake-compression stroke divided injection mode, wherein
the fuel pressure control means performs a combustion improvement control in which the fuel pressure is reduced, when the combustion deterioration of any cylinders is detected by the combustion state determination means.
